(19) United States
(12) Patent Application Publication
(10) Pub. No.: US 2006/0084039 A1
(43) Pub. Date: Apr. 20, 2006

(54) Drawing tool for capturing and rendering colors, surface images and movement

(75) Inventors: Kimiko Ryokai, San Francisco, CA (US); Stefan Marti, San Francisco, CA (US); Hiroshi Ishii, Cambridge, MA (US)

Correspondence Address: CHARLES G. CALL, 1161 Marlin Court, Marco Island, FL, 34145-5809, US

(73) Assignee: Massachusetts Institute of Technology, Cambridge, MA (US)

(21) Appl. No.: 11/253,997

(22) Filed: Oct. 19, 2005

Related U.S. Application Data
(60) Provisional application No. 60/620,234, filed on Oct. 19, 2004.

(51) Int. Cl. G09B 19/00

(52) U.S. Cl. 434/155

(57) ABSTRACT

An interactive drawing tool aimed at young children, ages four and up, to explore colors, textures, and movements found in everyday materials by “picking up” and drawing with them. The tool looks and feels like a conventional hand-held paintbrush but has a small video camera with lights and touch and orientation sensors embedded inside. Outside of the drawing canvas, the brush can pick up color, texture, and movement of a brushed surface, either from objects or surfaces, or from an electronic palette that stores captured images and colors for repeated use and may be implemented by a tablet computer. On the canvas, children can draw with the special “ink” they just picked up from their immediate environment. The canvas comprises a display screen combined with a brush position sensor coupled to a personal computer which also receives image and control data from the brush.

### CROSS REFERENCE TO RELATED APPLICATIONS

This application is a Non-Provisional of, and claims the benefit of the filing date of, U.S. Provisional Patent Application Ser. No. 60/620,234 filed on Oct. 19, 2004, the disclosure of which is incorporated herein by reference.

### REFERENCE TO COMPUTER PROGRAM LISTING APPENDIX

A computer program listing appendix is stored on each of two duplicate compact disks which accompany this specification. Each disk contains computer program listings which illustrate implementations of the invention. The listings consist of three Macromedia Director MX scripts and one C language source file, all recorded as ASCII text in IBM PC/ MS DOS compatible files which have the names, sizes (in bytes) and creation dates listed below:

| File Name | Bytes | Created |
|---|---|---|
| iobrush_main.txt | 38,715 | Oct. 3, 2005 |
| iobrush_palette.txt | 98,062 | Oct. 3, 2005 |
| iobrush_artpiece.txt | 5,094 | Oct. 14, 2005 |
| microcontroller_c.txt | 8,397 | Oct. 14, 2005 |

### FIELD OF THE INVENTION

This invention relates to graphical image sensing, generation and rendering systems.

### BACKGROUND OF THE INVENTION

Creating visual art, the process of choosing colors, determining where a line should go, selecting shapes, and discovering the effects of different combinations, seems to contribute to children's cognitive development. Through visual art, children not only develop conceptual understanding of the elements and principles of design [see Naested, I. R. Art in the Classroom. An Integrated Approach to Teaching Art in Canadian Elementary and Middle Schools, Harcourt Brace & Company, 1998] (which include color, shape, line, form, texture, contrast, pattern, and balance), but also develop their ability to classify, sort, think critically, and communicate [see Goldberg, M. Arts and Learning: An Integrated Approach to Teaching and Learning in Multicultural and Multilingual Settings, Longman, 1997]. Such activities through visual art may be especially important for young children who do not yet read and write, as drawing serves as a non-laborious way to represent their ideas on a paper and allows them to reflect on their thoughts through abstract representations [see Teale, W. H. & Sulzby, E. Emergent Literacy: Writing and Reading, Ablex, 1986].

Yet the success of such abstract thinking may depend on how it is grounded in the child's own reality. Indeed, school oriented (namely American middle-class) parents make great efforts to create connections between new concepts and real life by talking about them (e.g., “The duck in this book is yellow, just like the one in our tub!”) [see Heath, S. B. Ways with words. Language, life, and work in communities and classrooms, Cambridge University Press, 1983.] The new information the child is trying to make sense of needs to be grounded in some reality to be useful, but cannot be if it hasn't been acquired in terms of that reality [see Schank, R. C. & Cleary, C. Engines for Education, Lawrence Erlbaum Associates, 1995]. Therefore, learning to deal with new concepts while staying connected with familiar surroundings and objects seems to be important in developing new skills.

There are many sophisticated, commercially available drawing tools designed for children today. KidPix™ software by Craig Hickman, Broderbund Software, 1991, is one of the classic multimedia drawing software programs that allow children to paint with a variety of digital ink, as well as to play with their art by adding preprogrammed special effects such as wipe, glitter, and even some sound effects. Kai's Power Goo by Scansoft™ lets children manipulate realistic digital pictures (e.g, pinch/stretch a scanned-in picture of a face). Other software tools allow children to stamp or draw with clip art (e.g., a butterfly, tree, smiley faces, etc). While these commercially available tools are capable of importing more personal images from children's life, because of the number of steps involved in scanning in a single image, parents and children usually end up playing only with the clip art the software comes with.

On the other hand, more economical digital imaging devices such as still and video cameras are available today. Despite of young children's fascination with cameras and photographs, the use of such devices and the access to digitally captured images are still quite limited for young children.

Children tend to spend more time investigating their projects when the material they work with directly concerns their personal objects and interests, and feel that they have a special sense of ownership [see Papert, S. Mindstorms, Basic Books. 1980; and Resnik, M., Rusk, N. & Cooke, S. The Computer Clubhouse: Technological Fluency in the Inner City. High Technology and Low-Income Communities. Prospects for the Positive Use of Advanced Information Technologies,_MIT Press, 1999]. It is accordingly desirable to provide a technology that allows young children to take samples (specifically, the color, texture, and moving patterns), which can be found in their immediate environment, and use these personal elements to build their visual art projects. In this way, children are not only constructing visual art projects of their interests, but also working with the palette they find meaningful. If children work with their own palette, they are more likely to investigate the elements and principles of design than working with a preprogrammed digital palette.

Technology that provides building blocks for children's design activities has been successful in learning domains beyond math and science. For example, MOOSE Crossing [see Bruckman, A., MOOSE Crossing: Construction, Community and Learning in a Networked Virtual World for Kids. PhD Thesis, Massachusetts Institute of Technology, Cambridge, Mass.; 1997] invited children to construct a virtual environment in which they could interact with each other. While a fun environment for children to program virtual objects and characters, MOOSE Crossing also served as a forum for children to practice their narrative writing skills.

KidPad, developed at the University of Maryland [see Druin, A., Stewart, J., Proft, D., Bederson, B., Hollan, J. “KidPad: a design collaboration between children, technologists, and educators,” Proceedings of CHI'97, ACM Press, (1997)] is a drawing program that supports the rich storytelling associated with children's drawings. Zoom-in and zoom-out tools in KidPad allow children to embed and hyperlink their drawings in order to build a complex visual story. KidPad offers a whole new lens for children to build and share their visual art.

Tangible user interfaces [see Ishii, H. and Ullmer, B. “Tangible Bits: Towards Seamless Interfaces between People, Bits and Atoms,” Proceedings of CHI'97, ACM Press, (1997), pages 234-241.] were applied to technologies for children to take advantage of physical affordances. A series of tangible “tools to think with” were invented at the MIT Media Lab, including “Digital Manipulatives” [see Resnik, A., Martin, F., Berg, R., Borovoy, R., Colella, V., Kramer, K., Silverman, B. “Digital Manipulatives: New Toys to Think With,” Paper Session, Proceedings of CHI'98, ACM Press, 2, (1998), 81-287] and “CurlyBot” [see Frei, P., Su, V., Mikhak, B., and Ishii, H. “curlybot: Designing a New Class of Computational Toys,” Proceedings of CHI2000, ACM Press. (2000), 129-136.] were designed to allow even young children to explore concepts of mathematics and geometry by programming with their own physical movements. These physical tools invited children's natural inquiry and discussion about rules, shapes, and numbers in a playful context.

SAGE [see Bers, M. U. and Cassell, J. “Interactive Storytelling Systems for Children: Using Technology to Explore Language and Identity,” Journal of Interactive Learning Research 9(2) (1998), 183-215] and StoryMat [see Ryokai, K. and Cassell, J. “Computer Support for Children's Collaborative Fantasy Play and Storytelling,” Proceedings of Computer Supported Collaborative Learning '99, Palo Alto, Calif., (1999), 510-517] on the other hand, embedded technology inside of children's familiar objects, especially soft materials such as stuffed animals and quilts, to support language development and storytelling that happen around these objects.

In the Physical Interactive Environments project at the University of Maryland [see Montemayor, J., Drum, A., Farber, A., Sims, S., Churaman, W., & D'Amour, A. “Physical programming: Designing tools for children to create physical interactive environments,” Proceedings of CHI2002, ACM Press. (2002)] a series of physical programming tools was developed in order to allow young children to design their own interactive physical space to tell stories. The researchers worked with children in their environment intensively to come up with usable technologies for children and teachers in real classrooms and homes. More recently, efforts to focus on open low-tech technologies rather than over-polished products have been made [see Stanton, D., Bayon, V., Neale, H., Ghali, A., Benford, S., Cobb, S., Ingram, R., O'Malley, C., Wilson, J., Pridmore, T. “Classroom collaboration in the design of tangible interfaces for storytelling,” Proceedings of CHI2001, ACM Press, and Decortis, F. & Rizzo, A. “New Active Tools for Supporting Narrative Structures,” Personal and Ubiquitous Computing, Volume 6 Issue 5-6, 2002].

Our natural routine to picking up elements in order to transfer the content to some other location has been studied and applied to the digital domain for quite some time. Pick- and-Drop [see Rekimonto, J. “Pick-and-drop: a direct manipulation technique for multiple computer environments,” Proceedings of the 10th annual ACM symposium on User interface software and technology (1997).] is a pen-based direct manipulation technique that lets the user transfer a computer document from one computer to another. Anoto™ pens [see Löwgren, C. “Anoto” Proceedings of Man Machine Interface for Mobile, Rome. (2000)] and other sophisticated handwriting capture tools are available today as office handwriting tools. The goal of these smart pens is to capture detailed handwritten notes, and not to pick up a variety of colors and materials.

The Colortron™ spectrophotometer available from X-write of Grandville, Mich. 49418 is a handheld device for fashion designers that can pick up any color in the physical world and return the numeric value of the color so that the designer can have the precise color number to work with in their design software. Colortron is accurate in computing the colors, but it is not designed as a tool to draw with, so that the designers must work with separate tools for drawing/sketching their designs. Sharaku by Fuji Xerox is a scanner and an ink-ribbon printer in one handheld device. It was not designed as a drawing tool but rather for transfering texts and images.

Technologies to control digital images as ink have been developed and are commercially available. For example, the Image Sprayer tool in Corel's Photo-Paint and the Magic Nozzle tool in Fractal Design Painter are sophisticated drawing software tools that allow users to spray any bitmap image on a digital canvas. However, a number of processes are involved in preparing the images to draw with, so the users generally end up drawing only with the software's clip art images. Photomosaics by Rob Silvers [see Silvers, R. Photomosaics, Henry Holt and Company, Inc. 1997.] incorporates algorithms to use thousands of images as pixels. Drawing Prism [see Greene, R. “The drawing prism: a versatile graphic input device,” ACM SIGGRAPH Computer Graphics, Proceedings of the 12th annual conference on Computer graphics and interactive techniques, July 1985. Volume 19 Issue 3] is a large optic-based translucent prism on which any light-colored object (e.g., light colored brushes and human hand) can be used as an input device. Easel [see Rozin, D. Easel. http://fargo.itp.tsoa.nyu.edu/˜danny/easel.html] is a large physical painting easel equipped with video cameras and a video projector. The artist can paint with live video images captured by the cameras positioned near the canvas (e.g. aiming at the artist him/herself or a room). Surface Drawing developed at Caltech [see Schkolne, S., Pruett, M., & Peter Schroder. “Surface Drawing: Creating Organic 3D Shapes with the Hand and Tangible Tools,” Proceedings of CHI2001, ACM Press. (2001)] is another interesting approach for using the body as the brush in a completely virtual environment. Users may either wear a glove or use a tangible tool to directly draw in the virtual environment.

Efforts to allow people to mix colors in the digital world have also been made. AntBrush [see Tzafestas, E. S. “Integrating drawing tools with behavioral modeling in digital painting,” Proceedings of the 2000 ACM workshops on Multimedia] is a software program that allows users to blend digital colors on a digital palette as if they were real paint. Digital Palette [see Heaton, K. B. Physical Pixels. Masters Thesis. Massachusetts Institute of Technology, 2000.] is a physical palette that allows users to mix colors of light. The user can then dip a small physical cube into the palette to paint the cube. The LEDs inside the cube change their color to give the effect of painting the physical cubes.

### SUMMARY OF THE INVENTION

In this specification, we describe a device we call “I/O Brush,” an augmented paintbrush that can pick up textures, colors, and movements from the real world, and allows children to immediately use, explore and make drawings with them.

The technology described empowers child and adult artists with the perspective behind the tools and materials, through creating and sharing visual art, made of/from personal objects. On the first level, the tools encourage artists to play multiple roles in the production of art, by allowing them to build their own paint box made from elements they find in their environment. These personal elements serve as powerful objects-to-think-with as they can be further edited, mixed, and processed during the creation. On the second level, the tools serve as the technology to document the artists' audio-visual narratives and explanations that are associated with the creation of art with personal objects. The technology helps artists record stories behind their creations, their choice of materials, and the history of the personal materials they use. On the third level, the technology allows the audience to gain access to those stories the artists left behind their art. Through the appreciation of both the art and the stories behind the creation and the materials that make up the art, the audience may gain new perspectives although they did not directly participate in the making of the portrait.

The preferred embodiment of the invention takes the form of methods and apparatus for generating a graphical image by manipulating a hand-held writing stylus that preferably takes the form of a brush with bristles at one end and incorporates one or more sensors for capturing image data that is indicative of the visual appearance of physical surfaces that the brush touches.

Thereafter, the brush is used to “paint” a graphical image on a “canvas” formed by a display screen. Means, such as a screen overlay, are used to detect the current position of brush as it is moved over the surface of the display screen. The image data captured earlier by the brush from one or more physical surfaces is displayed on the screen at a location corresponding to said current position of the brush during painting.

The images may be advantageously sensed by a camera mounted in the brush for capturing image data specifying a two-dimensional representation of said surface features. The camera may capture a moving image in a sequence of frames, or may derive a color signal from the image data to control the color of the image painted on the canvas.

The brush also preferably includes a light source which may be used to illuminate the surface whose features are being captured, and to further provide a visible indication to the user that images are being captured by the brush. The lights and/or the image capture process may be activated by pressure sensors in the brush which sense when the bristles are pressed against a surface.

The canvas preferably takes the form of a display screen for presenting an image produced by an image processor, such as a personal computer, consisting of a collection of image components, each of which is painted on the screen using the same brush that was previously used to capture image data representing the surface features from available objects. The display screen is supplemented by a position detector which generates position data indicating the position where the brush is located during painting. The position data is used in combination with the stored image data from the brush to compose new image components that are added to the display during painting.

The brush may be used with a palette: a secondary display screen where the artist can collect color or movement or texture samples in virtual, visible ‘reservoirs’. The artist can pick up the color/movement of any reservoir and paint with it on the main canvas. The user can also pick up the content of a reservoir and mix it with another reservoir or stroke on the palette, and then put the new color/textures back into a reservoir. There are multiple reservoirs on the palette, the number being limited only by the palette screen space. The palette screen may be produced by second processor that continuously exchanges information with the brush computer to specify which reservoir contains which ink, which ink the current brush is holding, which reservoir was selected recently, and other information.

### BRIEF DESCRIPTION OF THE DRAWINGS

FIG. 1 is a perspective view of the hand-held I/O Brush used to implement the invention;

FIG. 2 is a cross-sectional view of the I/O Brush;

FIG. 3 is a block diagram showing how the main components of the I/O Brush system are interconnected; and

FIG. 4 is a detailed schematic diagram of the microcontroller circuit used to implement the invention.

### DETAILED DESCRIPTION

Most drawing tools/pens we use today allow only a one-way flow of ink, and we are oblivious to how the content of the tool came to exist inside. What if we could not only have control over the outflow of the ink, but also have influence on what goes inside? Indeed, old fountain pens served as both tools to pick up and release the ink, and paintbrushes still preserve that function. We bring back this tradition of a drawing tool as both an input and output device, but instead of picking up the liquid ink, I/O Brush lifts up and captures photons.

Historically, before paint was sold in stores, artists searched for colors and patterns in real life and nature. In their art, artists tried to simulate the palette of colors they saw in nature. In the process, they extracted colors directly from clay, rocks, sand, and minerals. That is how the colors and pigments we use today came to exist [see Ball, P. Bright Earth: Art and the Invention of Color, Farrar Straus & Giroux; 1st American Edition, 2002; Delamare, F. & Guineau, B. Colors: The Story of Dyes and Pigments, Harry N Abrams, 2000; and Finlay, V. Color: A Natural History of the Palette, Ballantine Books, 2003.] Our hope is that I/O Brush will push children to develop the same kind of acute eyes as these artists had many years ago in identifying colors in their life.

We also found that the brush as a physical tool fits well in achieving the goal of reinventing the tool to pickup elements from the world, because the brush as an input device affords much more intimacy than pointy pens or syringes. Because of its soft tip, the brush is often used as a tool on our body (e.g., makeup brush, hair brush, lint brush, etc). The brush is perhaps one of the few tools that we allow to touch soft surfaces like our face.

The present invention empowers people today to develop the same kind of acute eyes as artists had many years ago in identifying colors in their life and made a color palette directly from the nature. Instead of squeezing out colors from the paint tubes bought from an art supply store, the proposed work invites child and adult artists to extract visual attributes of objects found in their personal environment, and immediately use these attributes to make drawings.

Inviting people to play the role of “color maker” as well as that of a painter may be an important exercise that leads to creative thinking as it encourages them to shift their perspectives and become aware that there are alternatives to what they already know. The proposed system tries to create that kind of inquiry about alternatives by having artists play multiple roles that force them to cross the boundary between painter and color maker. As it gives artists a connection to and a sense of control over the materials they work with, the proposed work also reawakens the tradition of “craftsmanship” in the activity of drawing/painting.

When children and artists work with materials and objects that have personal meanings, they are naturally encouraged to go beyond the immediate value of “what it is,” and are pushed to deal with multiple meanings of “what it represents” or “what it could be” that is associated with these materials and objects. For example, when a child paints her princess's hair brown (in a portrait) with brown-colored fluffy texture taken from her own teddy bear, the child is engaged in a transformation of a concrete object into new meanings in several different ways. First, the child is engaged in an abstraction by extracting a feature of her teddy bear (i.e., the color brown) and transforming it into the color of another (i.e., hair of a princess). Yet, at the same time, the child may be also taking the meaning associated with her personal teddy bear (e.g., the softness, warmth, and even love) and transferring that to the property of another (e.g., the softness of the princess' hair in the portrait).

To look at it in another way, the proposed technology encourages children and artists to create a palette of colors that have symbolic function. In the proposed approach, an abundance of opportunities for such kind of symbolic transformations are provided as the materials and objects children and artists work with are charged with personal meanings. The invention provides a physical palette on which children and artists can mix and process the materials they collected from their environment and build a whole new personal palette of colors. The personal materials they collect become objects, which they can further explore by adding and combining new elements. For example, a child may gently brush over his eye with the Brush to capture the image of his eye. He can drop off the “ink” on the palette, and take another element, color of green, from his favorite “Hulk” backpack. He can then mix/combine the two elements on the palette to make the special “green eye” ink that is made of his own eye and the color that came from his favorite backpack.

The space to modify and process elements of their personal objects is important as it gives children and artists not only the opportunity to explore features that consist of the objects they are familiar with, but also to combine them in creative ways. The invention provides an opportunity for children to explore their personal materials through playful modification and transformation that leads to creative thinking. For adult artists, the palette becomes a space where they are able to extract and experiment with features of familiar objects to create new forms.

Implementation

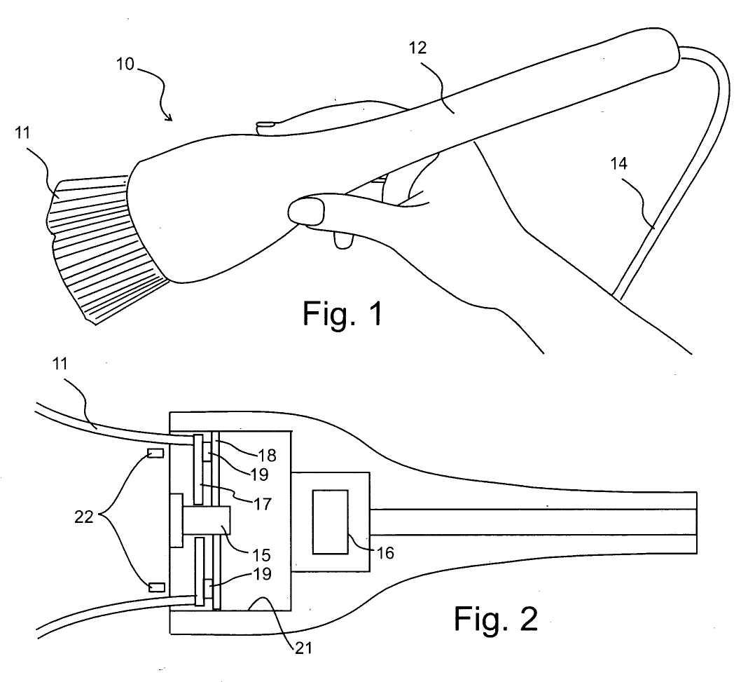

The I/O Brush system has three components: the brush, the drawing canvas, and the palette. As seen in FIG. 1, brush indicated generally at 10 shaped like a large, handheld paintbrush has bristles 11 on the enlarged end of a body housing 12. The body housing 12 is a wooden body constructed of hard maple turned on a lathe that contains or supports all the brush electronics, sensors, camera, bristles, etc. A camera seen at 15 mounted within the brush end of the housing 12 as seen in FIG. 2.

An inclinometer 16 is positioned behind the camera 15. The inclinometer 16 is a commercially available sensor, a Signalquest SQ-SI2X-360DA Series, manufactured by Signalquest, Inc. of Lebanon, N.H. The sensor provides a digital serial output corresponding directly to a full-scale range of 360° of pitch angle and 180° of roll angle. The inclinometer continuously monitors the rotational angle of the brush in two axes with a high resolution and accuracy and is coupled by a USB connected to the computer. Note that in addition to this information, the values from the four pressure sensors (each in 10 bit resolution, providing values between 0 and 1023) also indicate the tilt angle towards the canvas during painting. Therefore, during painting, rotating the brush will rotate the image, and tilting the brush will create an elliptical brush pattern, very much like physical brushes do: the more the brush is tilted, the more the brush pattern (‘mask’) becomes elliptical.

The I/O Brush is configured to not only look like a real brush but also to feel like one. Accordingly, the soft acrylic hair from real paintbrushes was transplanted onto the tip of I/O Brush, giving it the authentic feel of a soft brush tip. As seen in the cross-sectional view of FIG. 2, the bristles 11 are hot glued to a waterjet cut outer ring 17 made of aluminum. The outer ring 17 is attached to an aluminum inner ring 18, which is slightly bigger diameter. The two rings are attached to each other by four force sensors 19 distributed at 90 degree intervals around the rings to guarantee maximum sensitivity. Thus, when the brush bristles are brought into contact with a physical surface, the bristles apply pressure to the outer ring 16 that is sensed by the sensors seen at 19.

The force sensors 19 are attached to the inner ring 18 with thin double-sided tape, and with double-sided foam tape to the outer ring 16. The foam tape is necessary to (1) distribute the force evenly over the sensor, and (2) buffer the pushing force (vertical travel of the outer ring) that gets applied when the user presses the brush to an object or surface. To prevent the two rings from getting pulled apart (negative pressure), there are two safety screws (not shown) that span the two rings, but do not apply force to them. In order to not influence the sensor readings, the holes in the rings are larger in diameter than the diameter of the screws, and the nuts are not tightened completely: the nuts, two for each screw on the outer ring side, are secured with a drop of epoxy glue, instead.

The orientation of the brush with respect to the canvas, as detected by the combination of force sensors and the inclinometer, affects the orientation of the ink. The ink captured by I/O Brush is essentially an image with an orientation. For example, if a person use the brush to sample an given object sideways, the eye would appear on the canvas sideways as well. In actual use, it was observed people attempted to turn the applied ink by rotating the brush as they drew. But the ink did not turn with the brush, since there was originally no mechanism to support that interaction. The solution was to later add the inclinometer 16 inside the brush. The resulting ink effect yields more expressive capabilities through the physical interaction with the brush in addition to the pressure.

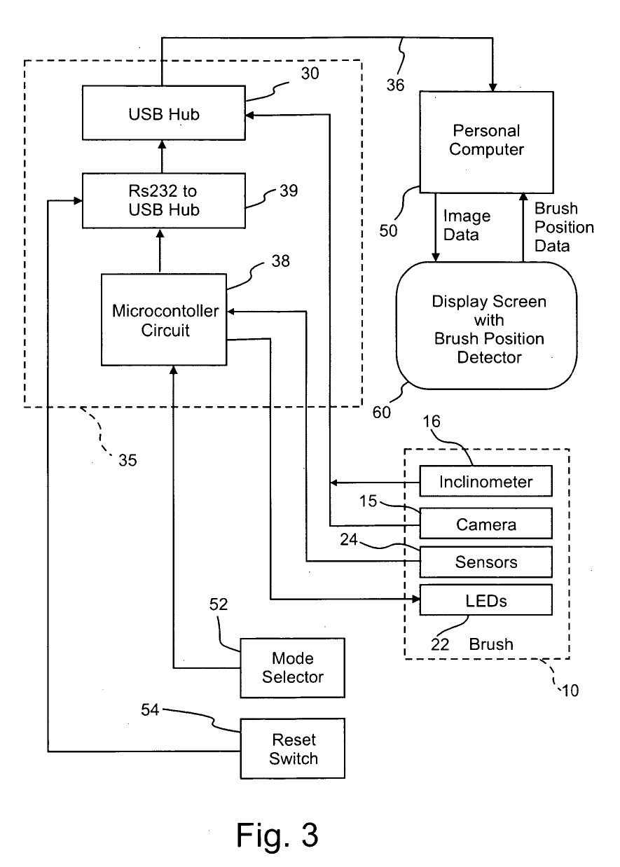

An electrical cable 14 that extends from the end of the body housing 12 opposite to the brush end may be used to connect the electrical components housed within the brush to a control circuit seen at 20 in the block diagram, FIG. 3. Alternatively, the brush may be connected to the remainder of the system by a short range Bluetooth® radio link.

The sensors 19 are preferably Force Sensing Resistors (FSRs) such as model 400 FSR sensors available from Interlink Electronics. These sensors are very thin, comprising several layers of polymer film, and are sturdy and reliable, but (as noted above) the FSRs should not be subjected to significant negative (pulling) forces which might cause the components of the film to separate. In order to prevent negative forces, the two screws described above are used.

The camera 15 may take the form of a small (3×3cm) CCD video camera 15, such as a Logitech Webcam which communicates with external circuitry via a standard USB connection. The camera 15 is mounted within in a cylindrical cavity 21 formed within the enlarged, bristle end of the brush housing 12. The camera 15 is surrounded by four LEDs (light emitting diodes) 22 which illuminate the immediate scene in front of the camera when the brush is brought near a physical surface whose external appearance is to be captured by the camera 15. When the bristles 11 touch a surface (as detected by the sensors 19), the lights 22 which surround the camera 15 briefly turn on to provide supplemental light for the camera. During that time, if the video frame(s) captured by the camera 15 are transferred via the USB Hub 30 seen in FIG. 3 to a connected personal computer (PC) 50 for storage and processing.

After frames have been captured, fiber optic bristles in the brush tip (which are combined with acrylic bristles 11 of the kind used in conventional paintbrushes) are illuminated by a laser diode. The fiber optic bristles are physically connected to the laser diode which is located in the main brush body; however, this feature was eliminated in a later version because the fiber optic bristles were not as soft as the acrylic brushes. Note that the LEDs and laser lit fibre optics are two different light sources which provide two different functions: the LEDs illuminate the scene for the camera DURING the capturing of images, whereas the tips of the fibre optics are lit AFTER the user has captured images and remain lit until the user starts painting with the ink on the canvas. Lighting up the bristle tips is meant to show the user visually and intuitively whether or not the brush has already picked up ink or not. If the bristle tips are lit, there is ink, and artist can go ahead with painting, otherwise there is no ink yet.

The “canvas” upon which the brush writes is a large, touch-sensitive screen display which senses the position of the brush on the screen. The canvas may take the form of an output display screen, such as a conventional CRT, LCD or plasma screen, or front or back projected screen, modified to provide a mechanism for determining the position of the brush end relative to the screen surface when it is brought into contact with, or moved very near to, the surface of the screen. For example, the canvas may take the form of a relatively large LCD or plasma display panel connected to display an image from a PC graphics card, combined with a position sensing device such as the NextWindow optical overlay available from NextWindow Ltd. of La Grange, Ill. The NextWindow overlay uses optical imaging techniques to record the touch point by means of an infra-red illuminated frame in combination with line-scan cameras that determine the touch point.

Alternatively, the canvas may take the form of a Wacom Cintiq screen with a built-in graphics tablet which is available from Wacom Co., Ltd. of Vancouver, Wash.: Wacom tablets are described in U.S. Pat. Nos. 6,689,965, 6,020,849 5,898,136, 5,028,745, and 4,878,553, the disclosures of which are incorporated herein by reference. When a Wacom tablet is used, the Wacom stylus is embedded inside the I/O Brush's tip to permit the Wacom sensors detect the presence and position of the brush relative to the screen.

Although the Wacom Cintiq screen is relatively large for an LCD screen, the size of I/O Brush can be more easily used with a bigger screen. In a demonstration version, we used a much larger 50-inch infrared vision based touch panel over a back projection screen. This scale worked well with the physical scale of I/O Brush. People, small children, moved and spread out using the whole canvas.

The I/O Brush is preferably accompanied by a physical “palette” which serves as a platform to collect and process ink before applying it to the canvas, just as artists do when painting with real water color or oil paint.

The palette offers a place to work with the ink. One of the most interesting and important observations made during the development of the I/O brush was how people preferred seeing what they are picking up with I/O Brush prior to painting with the ink on the canvas. In a development version, a small window in the corner of the canvas served as a monitor for displaying the image being captured by the video camera inside the brush. This window was left open so that we could see the camera inside the brush adjusting/focusing to the surface in real time. It was found that users liked to see exactly what they were picking up from the camera and frequently looked at the monitor window. However, there was a bit of awkwardness to having a “preview” window on the painting canvas as the window intruded the canvas space. An artist also had to look away from the physical objects they were sampling and look at the screen. To solve this problem, we provided another space dedicated for such an intermediate process, kept away from the canvas but closer to the artist.

The resulting palette appears on the corner of the large canvas, but may also be implemented on the screen of a separate tablet PC that artists can hold in their hand as they work with the I/O brush. On the palette, artists can sample and drop off multiple inks on a palette space. In a prototype, up to 5 different distinctive inks can be stored on the palette so that the artist can go back and forth between these inks. To pick up an old ink, the artist simply brushes over the reservoir and the software assigns the ink as the current ink so that the artist can paint with it. The rest of the space on the palette is dedicated for mixing multiple inks. An artist can “mix” multiple inks by drawing in the space with multiple inks. By layering the multiple inks in the space, the artist can also create new ink. The mixed paint can then be picked up as new ink.

The preferred embodiment of the I/O Brush described here has three modes for “picking up ink:” texture, color, and movement. The texture mode captures a single frame, two-dimensional image of a physical surface snapshot of the brushed surface by using the camera 15 to take a snapshot of the surface. The color mode computes the RGB values of all the pixels in the captured frame (resolution of 640×480) and returns the most common RGB value so that the child can draw with a solid color. The movement mode grabs up to 30 consecutive frames of the brushed surface and lets the child draw with the movement. When the child moves the brush across the canvas, the system drops off the successive frames, each frame showing the captured 30-frame animation in a loop with a slight temporal offset. For example, the child could brush over a surface with a stripe pattern for a couple of seconds. S/he could then paint with that moving ink to apply a ‘scrolling’ stripe design on the canvas. Or, the child could brush over his/her own blinking eye with the brush, and apply that ‘blinking-eye’ ink to paint the eyes of a cat on canvas.

The paint in all three modes is masked to appear as a round shape and its translucency level is set to a slightly lower value so that the child can layer ink like water color by quickly moving the brush, or paint with thick color by slowly moving the brush. The brush allows the child to paint with the same ink indefinitely until s/he picks up different ink. The modes are switched by the simple turn of dial on the frame of the canvas which operates the mode selection switch seen at 52 in the drawings.

Components

As depicted in the block diagram of FIG. 3, the whole I/O brush installation consists of the following principle components:
a. the brush 10;
b. a brush interface circuit 35 consisting of a control circuit 40, a USB hub 30, and an RS232 to-USB Hub interface 43;
c. a personal computer PC seen at 50; and
d. an overlay touch panel 60 which provides the “canvas.”
e. a laptop, PDA, or PC with touch sensitive screen (tablet PC) as the palette

The brush interface circuit 35 provides a single USB connection 36 between the brush 10 and the PC 50. A microcontroller circuit 38 digitizes signals from the sensors 24 in the brush 10 and sends them via an RS232 connection to an RS232 to USB interface 39. The control circuit 38 also energizes the LEDs 22 in the brush when the brush touches an object to pick up images or a color. A mode selector switch 52 and a reset switch 54 on the brush are connected to the control circuit 35 and the RS232C to USB interface circuit respectively. The reset switch 54, when actuated, sends an interrupt signal to the PC that stores the current drawing to a file, and then restarts that display program executing on the PC, effectively erasing the program memory and restarting with a blank screen. The USB signals from the RS232-to-USB interface circuit 39 and from the USB camera 15 and inclinometer 16 in the brush are collected in the USB Hub 30 which is connected via a USB cable 36 to the PC 50.

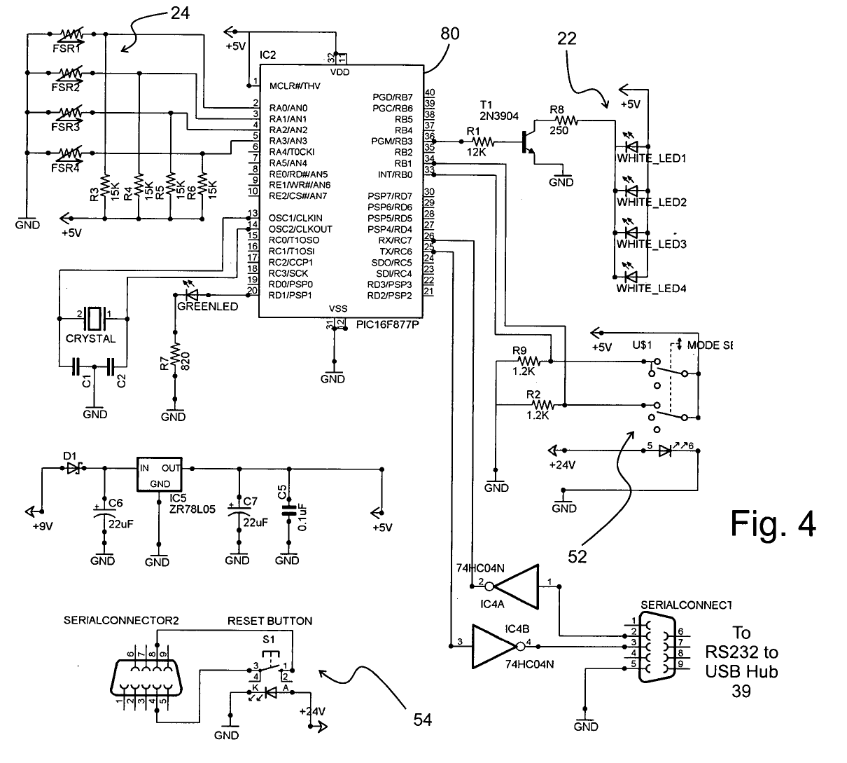

The details of the microcontroller circuit 38 are shown in FIG. 4. A PIC18F877P microcontroller is connected to the FSR sensors at 24 and to the LEDs at 22. The microcontroller is programmed as described in the microcontroller source code listing which is included in the computer listing appendix on the CD ROM that accompanies this specification. The sensor outputs, and the settings of the mode switch 52 and the reset switch 54 are communicated via RS232 connections to the RS232 to USB interface 39 and then via the USB connection 36 to the personal computer 50 as shown in FIG. 3.

The large NextWindow touch panel overlay shown at 60 in FIG. 3 uses vision to detect objects on the screen. The NextWindow overlay is capable of measuring the presence of the soft bristles on a surface, whereas inductive and resistive touch technologies were not found to work reliably with the brush bristles. The NextWindow panel uses two cameras to detect the position of the objects on the screen. The display software is set up so that the upper left corner of the Windows desktop is also on the upper left corner of the overlay touch panel. This means, the lower part of the windows desktop is not visible, which is desirable, because that's where the few Windows icons are that cannot be removed from the desktop. These icons are not visible in projector mode. The graphics software that executes on the personal computer 50 is described by the Macromedia Director script listings presented in the attached appendix which were compiled into executable code that executes on the PC as a Windows “.exe” file.

Interactive Art Piece

The computer program listing appendix further contains a program listing of an “interactive artpiece” which works as follows: it is displays a static picture painted earlier by an artist using the I/O Brush as described above. When displayed, members of an audience can touch different ‘hotspots’ which operate like invisible hyperlinks to play short video clips (Quicktime movie files of approx. 5-20 seconds each) to show where this specific ink was harvested from. These videos are recorded separately, and hardcoded to the static picture. The interactive art piece, like the I/O Brush system program noted above, is compiled into an executable Windows PC (.EXE file) from the Macromedia Director script file reproduced in the appendix. The PC 50 may also store and display, on request, a demonstration and tutorial file, such as an avi, .wmv or .mpg file, that can be played on the Windows Media Player.

Instructions to Users

The following instructions explain how to use the I/O brush in each of its modes of operation:

In order to pick up something, press the brush towards an object. As soon as the white lights come up in the brush, it will start picking up “ink.” In normal mode, only the LAST picture will be kept. Remember, if the white lights inside the brush don't come on, or flicker, press a little harder when picking up, so that the lights are on as long as you touch the object. Once you have picked up an ‘ink’, you can paint on the screen. Move the brush slowly with light or medium touch. The lighter you press, the thinner the displayed image will be.

The user can turn the mode switch to place the brush into movie mode so that it captures a moving image of surfaces next to the brush. I/O brush can pick up twenty (or more) movies, each maximum 3.0 seconds long. In the movie mode, the camera 15 is a video camera that captures and records the moving image the camera sees. Hence, the movement may be created by moving the brush relative to a stationary object, or holding the brush camera near a moving object, such as the blinking eye of a human, or both. When the brush is applied to an area of the canvas, that area then displays the moving picture that was previously captured. Thus, for example, if the captured image was a blinking eye, and the brush is drawn across an elongated area of the canvas, a sequence series of eye images, all blinking, will appear on the screen in the areas touched by the brush.

There are other ways to use the movie mode: for example, brush over text (from the colorful books provided), and then paint on the canvas: the user will see that the line is changing colors as you move along the canvas.

If you switch the mode switch to select the color mode, the brush will pick up only the main color of what the brush sees. If you don't get the color that you expected from an object, keep the brush where it was and turn the knob to the middle position, and you will see what the brush sees right now. Adjust the position of the brush so that the brush sees as much as possible of the color you want, and turn the knob back to left. Then you should get the color you expect to get—but it is harder than you think! Very often, although the colorful object is in the middle, there is black or white color around it, which makes it difficult for the brush to find the real color. Note that the brush does not give you the average color of all the colors it sees, but the single color that it sees the most. In other words: if you brush over a yellow and red striped pattern, you will NOT get orange!

Two features of the movie mode should be noted: (1) In movie mode, not only the last image of the stroke is animated, but all images, and (2) the varying pressure during painting in movie mode is recorded along the stroke, as are changes the size and tilt of the stroke, just as they are when still images are captured.

You can clean the screen by pressing the reset button. Restarting takes a few seconds, during which you see a text display on the screen indicating that the restart is in process. As soon as the hourglass mouse driver disappears, the system is ready again.

Other hints: You CAN paint over the things that are already on the screen. You CANNOT paint over movies on the screen.

When painters are painting with real paint, they touch the portrait with their hands and fingers, taking a little paint off here or there, and smudging the corner of a stroke. In fact, when we worked with the kindergartener children, the children did a lot of touching to their portrait on the LCD screen voluntarily even when there was no interactivity through the screen. The use of a touch screen enables the artist to easily use “smudging.” At any time, the user can touch the drawing on the canvas (and on the palette) with her fingers and smudge the image, which creates a very natural and intuitive user interaction option for modifying and manipulating the image.

As a demonstration of the I/O brush, we developed a portrait that tells stories behind the material by employing a canvas with a memory. In one demonstration, in addition to installing the I/O Brush and its large canvas, we also prepared a finished art piece painted with the I/O Brush. This art piece also was an interactive demonstrational piece where each color in the portrait had an associated documentary film of where the ink came from. When the visitor touched a certain place on the portrait, the film of where the material came from emerged and played over the portrait briefly. For example, the petals of the flowers in a portrait were extracted from a ragged teddy bear. People quickly understood the idea and enjoyed finding out where the ink came from. Moreover, the activity picked the viewer's curiosity to inquire into the materials that made up the art.

This led to our implementation of the canvas that keeps a history of where the inks came from that works as follows: The video camera 15 inside the brush constantly streams video to the computer. A “history movie” consisting of the last 5 seconds before the brush makes the “touch down” is saved. The saved “history movie” is mapped to the brush strokes on the canvas, so when a person touches an area of the canvas, the history movie plays back on the canvas. In this way, the history movie captures the source of the ink, enabling both the artist and the audience to later identify where the ink originated (e.g. one may see the face of a person when capturing a blinking eye or a button from the person's jacket, etc.) This way, the canvas serves as a place to hold both the artist's portrait and the histories of materials used in creating the portrait.

The system ‘remembers’ where each stroke came from. Visual history means recording the last five seconds (the duration is configurable) of video before the user touched an object. The visual history can be played back by touching a specific area on the canvas with one or several finger(s). The history shows up as a temporary overlay, like a little pop-up video, and disappears after played back.

Similar to the visual history, the last five seconds of audio recorded at the same time the history video is recorded may be stored for each stroke, either instead or in addition to the video history movie,.and are played back together with the video on the screen when the audience is touching a certain stroke.

Mixing Colors

We intentionally designed the ink to have some transparency so that they can mix the colors on the canvas by applying successive layers of ink. However, to the children it seemed more natural to mix the ink in the physical world. Some children made attempts to mix colors by brushing off several different surfaces in sequence before applying the ink onto the canvas.

It seems important to make the brush wireless. While it was fun for the children to go out and find different items and come back with an armful of materials, some children at the end of the session said, “I wish it didn't have the wire so that I can walk around with it.” Even with a wireless brush, children will still need a large drawing surface to draw. When a separate handheld palette (implemented, for example, with a tablet computer or a PDA), both the brush and the palette may be coupled by a wireless connection to the main processor. Children may walk around with the wireless brush and the palette to collect samples in their environment. On the palette, the children may mix different colors, materials, and movements they have picked up, prior to applying them to the big canvas. This would resemble the real world more closely while allowing more flexibility.

Multiple brushes may be used for collaborative drawing activities. The current implementation introduced one brush with three different modes of picking up the ink. However, multiple brushes with each having its own personality/functionality, e.g., would invite more interesting collaborative painting among children.

Non-visual properties, such as sound, may also be captured by the system. Users could mix their favorite music with the pattern of their favorite shirt. This leads to the idea of a synesthetic drawing tool that does not only pick up visual properties but also auditory elements of the world we live in. For example, a microphone at the end of the brush could pick up speech and music. In the case of music, it would analyze these auditory samples for parameters like tempo, loudness, and homogeneity. Furthermore, I/O Brush could extract from these samples properties like music genre and associate a color palette and patterns with them. For example, aggressive, fast music, could create dark lines with jaggy patterns and high opacity, where as soft flowing, slow new age music would result in pastel colors with smooth patterns and high transparency. Of course the mapping between non-visual properties and concrete drawing styles will pose a considerable challenge. Even more challenging would be synesthetic mappings of olfactory properties of the real world to visual properties: e.g., the user could try to pick up the soft smell of a rose, and paint with the equivalent visual mapping of the smell, which will result in a different color palette than picking up the smell of, e.g., an onion. The artistic and creative possibilities in this direction would be tremendous, but also challenging.

Using I/O Brush, children not only produced complex drawings, but they also explored objects and materials that surround them, and during the process, explicitly talked about the elements and principle of design such as color, texture, and movement. Although the outcome of their artwork was digital, the process of their work involved searching for and interacting with many physical objects that are available and meaningful to them in their life. Through such exploration with familiar objects and constructing meanings through them, children learn to take control over underlying abstract concepts. I/O Brush has the potential to make this important connection.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A method for generating a graphical image comprising, in combination, the steps of:
manipulating a hand-held writing stylus incorporating one or more image sensors for capturing image data indicative of the visual appearance of surface features in the immediate vicinity of one or more image sensors,
thereafter detecting the current position of stylus when said stylus is moved adjacent to a display screen, and
displaying a graphical image derived from said image data on said display screen at a location corresponding to said current position.

2. A method for generating a graphical image as set forth in claim 1 wherein said stylus is a brush which includes resilient bristles at a distal end of said stylus.

3. A method for generating a graphical image as set forth in claim 1 wherein said one or more image sensors comprise at least one camera for capturing image data specifying a two-dimensional representation of said surface features.

4. A method for generating a graphical image as set forth in claim 3 wherein said image data specifies moving representation of said surface features.

5. A method for generating a graphical image as set forth in claim 3 wherein said writing stylus further includes a light source for illuminating said surface features when said stylus is in the immediate vicinity of said surface features.

6. A method for generating a graphical image as set forth in claim 1 further comprises the step of providing an indication to the person manipulating said stylus when said one or more image sensors capture image data.

7. A method for generating a graphical image as set forth in claim 1 further comprising the steps of detecting when said stylus is positioned in the immediate vicinity of said surface features and then activating said one or more image sensors to capture said image data.

8. Apparatus for creating and displaying a hand-drawn graphical image comprising, in combination,
an elongated hand-held drawing implement having a optical sensor on its distal end for producing surface feature data indicative of the characteristics of a physical surface when said distal end is positioned near or pointed at said physical surface,
an electronic display screen,
a position sensor for producing position data indicating a selected location on said display screen where said distal end is positioned, and
a processor for receiving said surface feature data and said position data and producing an image representative of said surface feature data at said selected location on said display screen.

9. Apparatus for creating and displaying a hand-drawn graphical image as set forth in claim 8 wherein said image date indicates the color of said physical surface.

10. Apparatus for creating and displaying a hand-drawn graphical image as set forth in claim 8 wherein said optical surface is a camera for capturing an image of said physical surface.

11. Apparatus for creating and displaying a hand-drawn graphical image as set forth in claim 8 wherein said drawing implement is a brush having bristles extending from said distal end.

12. Apparatus for creating and displaying a hand-drawn graphical image as set forth in claim 11 wherein, when said bristles are positioned adjacent to an area of said display screen at said selected location, and said image representative of said surface feature data extends over said area.

13. Apparatus for creating and displaying a hand-drawn graphical image as set forth in claim 8 wherein said apparatus further comprises means for generating a signal perceptible to the user of said implement to inform said user when surface feature data has been captured by said optical sensor.

14. Apparatus for creating and displaying a hand-drawn graphical image as set forth in claim 13 wherein said signal is a visual indication.

15. Apparatus for creating and displaying a hand-drawn graphical image as set forth in claim 14

16. Apparatus for creating and displaying a hand-drawn graphical image as set forth in claim 8 wherein said optical sensor comprises a camera for capturing a moving image of said physical surface in a sequence of frames and wherein said sequence of frames is displayed as a moving image on said electronic display screen.

17. Apparatus for creating and displaying a hand-drawn graphical image as set forth in claim 8 wherein said optical sensor is a camera and wherein said apparatus includes a mode selector operable by the user of said implement for producing an image consisting of either a color sensed by said camera, a two dimensional pattern captured by said camera, or a moving image captured by said camera.

18. Apparatus for creating and displaying a hand-drawn graphical image as set forth in claim 8 further comprising means for reproducing a selected audio recording at the same time said image representative of said surface feature is displayed.

19. The method of creating and displaying a graphical image comprising the steps of:
employing a hand held stylus equipped with an optical sensor at its distal end to capture sensed data representing the appearance of a physical surface adjacent to said stylus,
storing said sensed data in a data storage device,
employing said hand held stylus to produce position data specifying a selected location on a display screen by moving said stylus into contact with or closely adjacent to said selected location,
processing said sensed data and said position data to display an image component whose appearance is similar to the appearance of said physical surface on said display screen at said selected location.

20. The method of creating and displaying a graphical image as set forth in claim 19 wherein said sensed data includes data representing the color of said physical surface.

21. The method of creating and displaying a graphical image as set forth in claim 19 wherein said sensed data includes data representing the visible texture of said physical surface.

22. The method of creating and displaying a graphical image as set forth in claim 19 wherein said sensed data comprises a sequence of images representing a moving image of said physical surface.
